(19) United States
(12) Patent Application Publication
(10) Pub. No.: US 2009/0106203 A1
(43) Pub. Date: Apr. 23, 2009

(54) METHOD AND APPARATUS FOR A WEB SEARCH ENGINE GENERATING SUMMARY-STYLE SEARCH RESULTS

(76) Inventors: Zhongmin Shi, Vancouver (CA); Yabo Xu, Burnaby (CA)

Correspondence Address: FRANK F. TIAN, 331-4A THIRD AVENUE, LONG BEACH, NJ, 07740, US

(21) Appl. No.: 12/253,949

(22) Filed: Oct. 18, 2008

Related U.S. Application Data
(60) Provisional application No. 60/999,389, filed on Oct. 18, 2007.

(51) Int. Cl. G06F 17/30

(52) U.S. Cl. 707/3; 707/E17.108

(57) ABSTRACT

A method and apparatus for a summarization-based search engine is presented. This invention provides a concise answer to a user's query—an accurate and up-to-date summary—that is synthesized from multiple contents taken from the World Wide Web. In contrast to conventional search engines, such as Google and Yahoo!, which return the user a list of web links, page titles and sentence fragments, this invention generates more readable, informative, relevant and integrated answers in response to the user's query. Moreover, this invention has broad applications to different search platforms and specific domains. It particularly suits well for mobile devices, inasmuch as its results are more concise than those of conventional search engines.

### REFERENCE TO RELATED APPLICATIONS

The present application claims an invention which was disclosed in Provisional Application No. 60/999,389, filed Oct. 18, 2007, entitled “Method and System for a Web Search Engine Generating Summary-Style Searching Results”. The benefit under 35 USC §119(e) of the United States provisional application is hereby claimed, and the aforementioned application is hereby incorporated herein by reference.

### FIELD OF THE INVENTION

The present invention relates generally to Data Processing. More specifically, the present invention relates to Method and System for a Web Search Engine Generating Summary-Style Search Results.

### BACKGROUND

With the rapid development and percolation of technology into daily lives of individuals and businesses, the process of identifying useful information and making decisions has become more complex and cumbersome. There are billions of websites covering every possible fragment of every field providing inordinate amount of information to filter or process. To filter this information, traditional search engine companies, like Yahoo! and Google, have built search engines and prospered by providing faster response to queries and/or more accurate list of response. However, traditional search engines have following drawbacks:
Their search results contain thousands of page titles and links, instead of answers that the users look for. This can leave users in a condition tantamount to search for a needle in the haystack and make the whole process time consuming and cumbersome.
Such search results usually include a large amount of irrelevant information, and more essentially, lack of readability and contextual information.
Users may have to collect information from multiple pages, and summarize the information into answers by themselves.

On the other hand, online encyclopedias, such as Wikipedia, normally provide high-quality answers, but 1) only cover popular topics; 2) are updated manually by individual volunteering users.

The prior art of this invention, such as re-ranking mechanisms proposed in U.S. Pat. No. 6,591,261. Arthurs, Keith E. entitled “Network search engine and navigation tool and method of determining search results in accordance with search criteria and/or associated sites’; Issued in July 2003 (hereinafter merely Arthurs).

U.S. Pat. No. 5,864,846. Voorhees, Ellen et al entitled “Method for facilitating world wide web searches utilizing a document distribution fusion strategy” Issued in January 1999 (hereinafter merely Voorhees-001).

U.S. Pat. No. 5,864,845 to Voorhees, Ellen et al entitled “Facilitating world wide web searches utilizing a multiple search engine query clustering fusion strategy” Issued in January 1999 (hereinafter merely Voorhees-002).

Further see http://www.dogpile.com. See http://www.a9.com. See http://www.searchmash.com. The above publications focuse on improving the relevance of search results, rather than working on drawbacks of the traditional search engines.

Some known works have explored various forms of summaries as a way to capture the information on a single web page. For instance, see U.S. Pat. No. 6,581,057 to Michael J. Witbrock et al entitled “Method and apparatus for rapidly producing document summaries and document browsing aids”; Issued in June 2003 (hereinafter merely Witbrock).

Witbrock generates a topical summary for each web page at indexing time, and displays it when the web page is retrieved at search time. See U.S. published Patent application No. US20020078019 to Lawton, Scott S. entitled “Method and system for organizing search results into a single page showing two levels of detail”; Published on June 2002 (hereinafter merely Lawton).

Lawton goes further to produce two-level details for each web page: a topical summary and a more detailed description. Graphic information has also been proposed to associate with each relevant web page, for instance, page logos see Michael Wynblatt and Dan Benson in “Web Page Caricatures: Multimedia Summaries for WWW Documents” at pp. 194. ICMCS 1998 (hereinafter merely Wynblatt), thumbnails See Allison Woodruff et al in “Using Thumbnails to Search the Web. Conference on Human Factors in Computing Systems” Vol. 3, pp. 198-205. 2001 (hereinafter merely Woodruff).

For graphic information associated with snapshots of a webpage, See U.S. Pat. No. 6,643,641. Russell Snyder. Web search engine with graphic snapshots. Issued in November 2003 (hereinafter merely Snyder). All these publication, are however apply only to one single web page.

Multiple relevant web pages may be represented together by one set of information. Specifically, See U.S. published Patent application No. US20060155728 to Bosarge Jason entitled “Browser application and search engine integration” Published in July 2006 (hereinafter merely Bosarge). Bosarge proposes to collate multiple URLs into a single Multiple Resource Locator (MRL), such that clicking an MRL would load multiple pages into the browser. There is, however, no summarization of the web pages involved. A few works has also represented all relevant web pages by clusters and associated topical terms. See U.S. Pat. No. 6,862,586 to Jeffrey Thomas Kreulen et al. Searching databases that identifying group documents forming high-dimensional torus geometric k-means clustering, ranking, summarizing based on vector triplets. March 2005 (hereinafter merely Kreulen); and see Clusty the clustering search engine: http://www.clusty.com.

As can be seen, inside the web page clusters, web pages are still ranked and presented individually.

Therefore, it is desirous to address the drawbacks of traditional search engines by providing more concise, readable, relevant and integrated search results.

### SUMMARY OF INVENTION

The present invention aims to cover the drawbacks of traditional search engines by providing more concise, readable, relevant and integrated search results.

Embodiments of the invention, named Summarization-based Search Engine (SSE), provide mechanisms and techniques on automatically generating an article that summarizes web contents relevant to user's query into a concise and accurate answer to the query. This automatically updated summary contains paragraphs, bullets, tables, graphs, and/or other multimedia information, such as images, videos and sound tracks. The present invention has following advantages:
The summary is more readable and easily understandable. It contains less irrelevant information than other web search engines, which returns to users a list of web page title, one or two sentences or sentence fragments.
Users would find target web pages faster by fewer clicks, not only because they may find answers from the summary directly, but also because contextual information among sentences would help users to make decision more confidently and accurately.
The summary also includes a group of distinct sub-topics, which would help resolving ambiguity in the user's question and guide the user to narrow down or rephrase the search.
The summary would naturally include multimedia information, i.e., images, videos, sound tracks, etc. and is thus more informative than merely textual search results.

Other embodiments of this invention include the deployment of the SSE on hand-held devices, due to conciseness of the summary-style search results.

Still other embodiments include the application of Summba on a specific domain, such as product review search and travel search etc. Such applications of Summba may involve some changes to adapt to the specific domain.

A system comprises an user interface configured to enable an Internet user to input at least one query and receive at least one answer; a crawler for collecting web contents from the Internet; an indexer for receiving the query from said user interface and builds indexes of said web contents; and a retriever for looking up said indexes and generating said least one answer to said at least one query.

Note that this summary section herein does not specify every embodiment and/or incrementally novel aspects of the present disclosure or claimed invention. Instead, this summary only provides a preliminary discussion of different embodiments and corresponding points of novelty over conventional techniques. For additional details, elements, and/or possible perspective (permutations) of the invention, the reader is directed to the Detailed Description section and corresponding figures as further discussed below.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a flow diagram of our web search engine system generating summary-style search results, which consists of three sub-systems: Web Crawling, Indexing and Searching.

FIG. 2 is a flow diagram of Page Content Filter module of the system.

FIG. 3 is a flow diagram of Syntactic and Semantic Annotations module of the system.

FIG. 4 is a flow diagram of Sentence Ordering module of the system, which generates summaries by ordering sentences in terms of cohesion and coherence among sentences.

FIG. 5 shows an example of a search result: a summary of “global positioning system” generated by the present invention.

FIG. 6 shows an example of a search result from adapting Summba to a specific domain-product review search.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to Internet searching. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

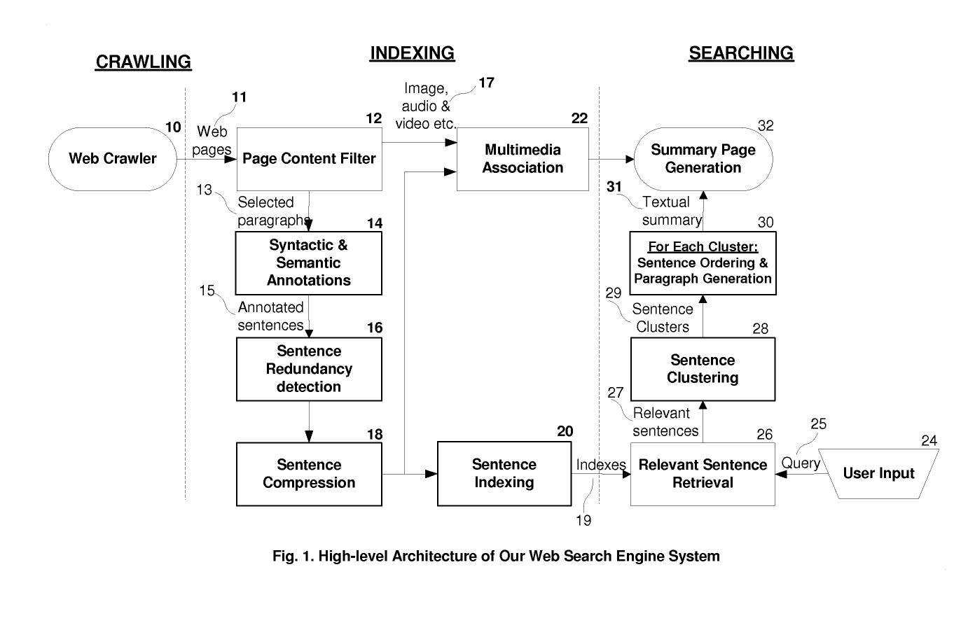

Our system comprises three sub-systems: Web Crawling, Indexing and Searching, as illustrated in FIG. 1.

The web crawling is a process of traversing the Web to retrieve web pages. A web crawler 10 starts from URLs, such as those listed in Open Directory Project (http://dmoz.org), and the URLs collected manually, traverses from link to link and collects all web pages 11 that are allowed or subject to access.

The indexing sub-system involves following steps to process web pages 11 and builds indexes of the web contents, which can then be queried by the searching sub-system:

A Page Content Filter 12 extracts valid paragraphs 13 and other multimedia sources 17, such as images, audio and video tracks from each web page. In order to do so, a Page Content Extraction block 34 removes functional and formatting codes, e.g., JavaScript, Applet, CSS, font and color settings and the like from the web page. A Paragraph and Multimedia Source Detection 36 extracts html paragraphs and information of multimedia sources 17 from rest of the page. Paragraphs with invalid form, for an example, too short in length or with no proper punctuations, are then be removed by a Invalid Paragraph Removal 38.

Different from conventional web indexing systems, the present web search engine analyzes webpage contents at syntactic and shallow semantic level by a Syntactic & Semantic Annotations 14. Firstly, a Sentence Boundary Detection block 40 splits selected paragraphs 13 into sentences. Sentences with invalid form, for an example, too short in length, without proper punctuations or initial capital, are then removed by Invalid Sentence Removal 42. Secondly, part-of-speeches (POS) and noun phrases (NPs) in each sentence are identified by a POS Tagging 44 and an NP Detection 46 respectively, both of which are well-studied Natural Language Processing tasks that can be normally accomplished by a set of linguistic rules. Lastly, Predicate-argument structure of each sentence is identified by a Semantic Role labelling 48, which basically includes a set of linguistic rules to recognize subjects, objects, manner, discourse and temporal arguments, etc., that are associated with each verb. The Syntactic & Semantic Annotations 14 finally produces annotated sentences 15 that contain the aforementioned syntactic and semantic information.

A Sentence Redundancy Detection 16 identifies sentences having same subject-verb-object structure. In case that a sentence redundancy is detected, only the most informative sentence, for instance, the longest or the one having most number of NPs, is kept. An alternative embodiment of the Sentence Redundancy Detection 16 is to keep all redundant sentences, thereby allowing the searching subsystem to choose one of them when creating the summary.

A Sentence Compression 18 removes unnecessary constituents, e.g., temporal and discourse arguments, words inside parentheses and dashed lines, from the remaining sentences.

A Multimedia Association 22 links each remaining sentence with the most relevant multimedia source, if any, in the original web page. The relevance is measured by 1) the number of sentences between the said sentence and multimedia source, 2) overlap of the said sentence and textual information, e.g., title, name, alt tag and the like, of the said multimedia source.

The remaining sentences are then indexed by Sentence Indexing 20. Different from traditional indexing methods, which are indexed at the page level, the web pages that have been parsed into sentences from 12 to 18 are indexed in a sentence level to facilitate further natural language processing in the searching sub-system.

The searching sub-system comprises the following steps: taking a user query 25, retrieving relevant sentences 27 from indexes by a Relevant Sentence Retrieval 26, and generating a summary consisting of relevant sentences 27 and their associated multimedia sources 17, if any. However, since it is common that the user query 25 is ambiguous or not specific enough, relevant sentences 27 would quite likely address various issues or sub-topics. Therefore the present invention implements a Sentence Clustering 28, which groups relevant sentences 27 based on the frequently occurring NPs. Specifically, each cluster is represented by a frequently occurring NP and each sentence is assigned to some cluster if containing the said NP. The user query is also included in the set of frequently occurring NPs and named “main topic” of the final summary. The rest of frequently occurring NPs are therefore named “sub-topics”.

A Sentence Ordering and Summary Generation 30 in turn generates a summary for each cluster represented by the main topic or sub-topic. The overall textual summary 31 is a collection of all cluster summaries in the order of frequency of corresponding topics. In order to do so, sentences in each cluster are ordered and grouped into paragraphs 57 by steps below: 1) A First Sentence Selection 50 locates the first sentence of the summary by giving priority in following order to sentences that are:

a) having no pronoun;

b) in “to-be” verb form;

c) first sentences in web pages;

d) first sentences in paragraphs; and

e) more informative, for instance, having more NPs.

2) The next sentence is chosen iteratively from remaining sentences. A cohesion measurement 52 calculates Overlap between previously chosen n sentences with each sentence of remaining sentences. Although not identified in the primary embodiment of our system, pronoun-referent pairs can be taken as overlapping NPs if they are identified (the technique to identify pronoun-referent pairs is called Coreference Resolution). A Next Sentence 54 chooses the next sentence with the largest overlap. The iteration stops when a certain number of sentences or all sentences have been chosen.

3) The ordered sentences 55 are then split into paragraphs 57 based on coherence among sentences, by Coherence Detection 56.

Finally, a Summary Page Generation 32 creates a web page of the overall textual summary 31. Each sentence of the summary contains the hyperlink to the source web page. Multimedia sources 17 that are associated with each sentence of the textual summary 31, if any, are also properly placed around the sentence.

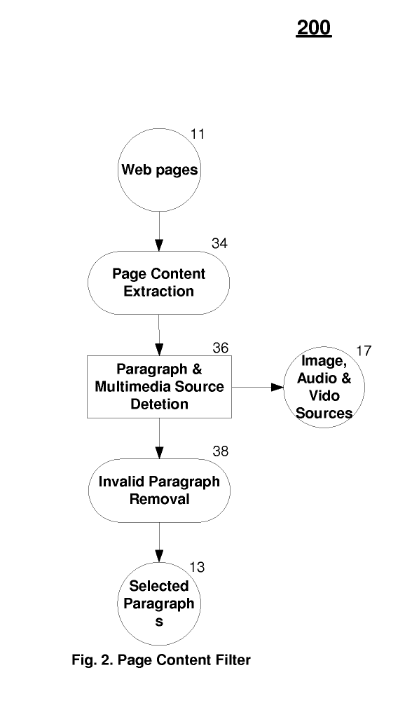

Referring to FIG. 2, a flow diagram 200 of Page Content Filter module of the system. The module extracts text and images from web pages. Provide a number of Web pages (Step 11). Extract page content (Step 34). Detect paragraph or multimedia source (Step 36). The multimedia source includes image, audio, and video sources. Remove invalid paragraph (Step 38). Whatever that is left remain the selected paragraphs (Step 13).

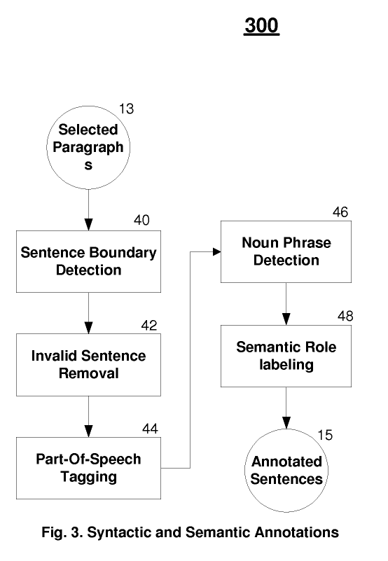

Referring to FIG. 3, a flow diagram 300 of Syntactic and Semantic Annotations module of the present invention is shown. The module identifies sentences, removes invalid sentences, and generates syntactic and semantic annotations of sentences. Provide a set of selected paragraphs (Step 13). The selected paragraphs may be the end results of FIG. 2. Detect sentence boundary (Step 40). Remove at least one invalid sentence if any (Step 42). Tag part-of-speech (Step 44). Detect at least one noun phrase if any (Step 46). Label semantic role (Step 48). Whatever that is left remain a set of annotated sentences (Step 15).

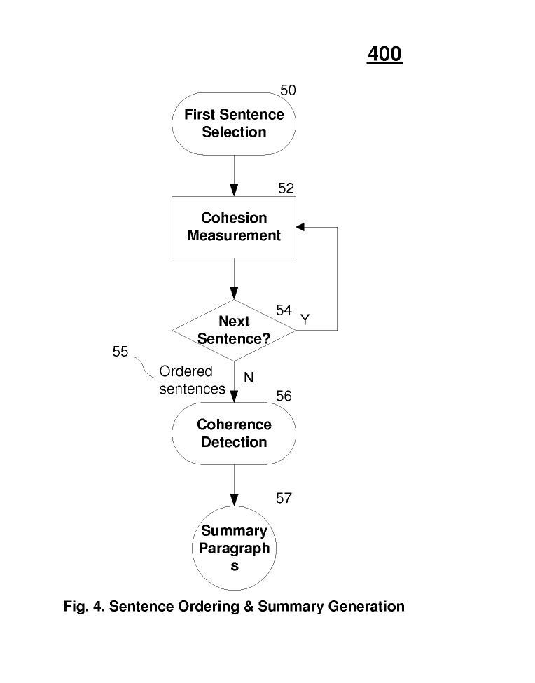

Referring to FIG. 4, a flow diagram 400 of Sentence Ordering module of the system, which generates summaries by ordering sentences in terms of cohesion and coherence among sentences, is shown. Select first sentence (Step 50). Measure cohesion (Step 52). Determine if there is a next sentence for measurement (Step 54). Revert back to step 52 if there is a next sentence for measurement (Step). Otherwise, subject the exiting ordered sentences 55 to a coherence detection (Step 56). Provided a summary paragraphs (Step 58).

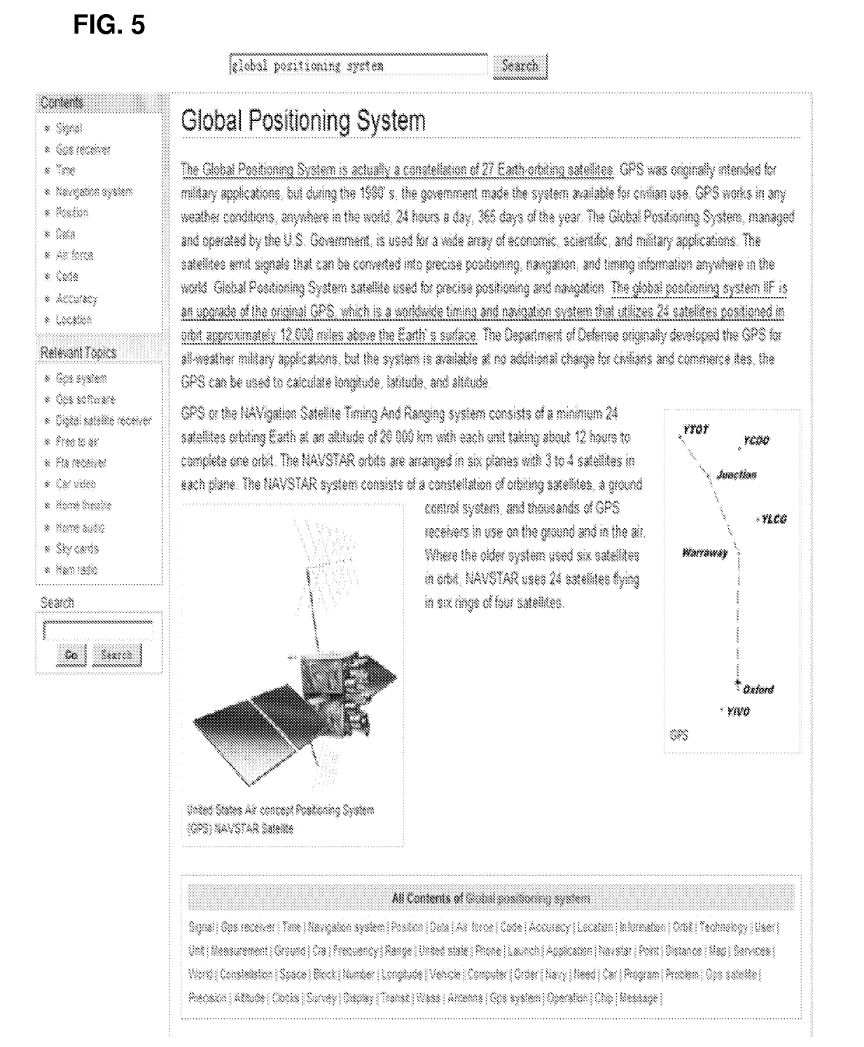

FIG. 5 shows an example 500 of a summary of “global positioning system” generated by our web search engine and the web page layout. The right column in the figure illustrates a summary of the main topic “global positioning system”. The summary of each sub-topic is contained in a separated web page, which can be accessed by clicking the sub-topic at the bottom of the page or at the top of the left column. An alternative representation of the researching results is to list all topic summaries in a single web page, which may result in a very long page layout.

Our invention also exploits clustering techniques, but mainly for the purpose of generating sub-topic summaries, but not clusters per se.

Having described the preferred embodiments of the invention, a general summarization-based search engine, it will now become apparent to those of ordinary skills in the art that other embodiments incorporating these concepts may be used.

In particular, an alternative embodiment is the deployment of Summba on mobile search platform. In this case, the only changes to Summba are that Sentence Ordering and Summary Generation 30, and Page Generation 32 may need to customize the length of summary to adapt to the small screens constraint on mobile devices. The concise summary, when applied to mobile search, has a clear advantage over the list of web links returned by the conventional search engines.

The other embodiments of this invention are the broad applications of Summba in specific domains, instead of being a general search engine. In this case, the web crawling sub-system would only retrieve web pages in this domain and the Sentence Clustering 28 would apply domain-specific ontology or dictionaries, if any, to credit those NPs that ontologically relate to the main topic. Additionally, the summary generated may be presented in different forms than in the general search, in accordance with the requirements in the specific domain.

It is submitted that this invention should not be limited to the described embodiments but rather should be limited only by the spirit and the scope of the appended claims.

Some of the embodiments are described herein as a method or combination of elements of a method that can be implemented by a processor of a computer system or by other means of carrying out the function of the present invention. Thus, a processor with the necessary instructions for carrying out such a method or element of a method forms a means for carrying out the method or element of a method associated with the present invention. Furthermore, an element described herein of an apparatus embodiment is an example of a means for carrying out the function performed by the element for the purpose of carrying out the invention. It will be understood that the steps of methods discussed are performed in one embodiment by an appropriate processor (or processors) of a processing (i.e., computer) system executing instructions stored in a storage. The term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors. It will also be understood that embodiments of the present invention are not limited to any particular implementation or programming technique and that the invention may be implemented using any appropriate techniques for implementing the functionality described herein. Furthermore, embodiments are not limited to any particular programming language or operating system.

The methodologies described herein are, in one embodiment, performable by one or more processors that accept computer-readable (also called machine-readable) logic encoded on one or more computer-readable media containing a set of instructions that when executed by one or more of the processors carry out at least one of the methods described herein. Any processor capable of executing a set of instructions (sequential or otherwise) that performs the functions or actions to be taken are contemplated by the present invention. Thus, one example is a typical processing system that includes one or more processors. Each processor may include one or more of a CPU, a graphics processing unit, or a programmable digital signal processing (DSP) unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., an liquid crystal display (LCD) or a cathode ray tube (CRT) display or any suitable display for a hand held device. If manual data entry is required, the processing system also includes an input device such as one or more of an alphanumeric input unit such as a keyboard, a pointing control device such as a mouse, stylus, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries logic (e.g., software) including a set of instructions to cause performing, when executed by one or more processors, one of more of the methods described herein. The software may reside in the hard disk, or may also reside, completely or at least partially, within the RAM and/or within the processor during execution thereof by the computer system. Thus, the memory and the processor also constitute computer-readable carrier medium on which is encoded logic, e.g., in the form of instructions.

Thus, one embodiment of each of the methods described herein is in the form of a computer-readable carrier medium carrying a set of instructions, e.g., a computer program that are for execution on one or more processors, e.g., one or more processors that are part of a communication network. Thus, as will be appreciated by those skilled in the art, embodiments of the present invention may be embodied as a method, an apparatus such as a data processing system, or a computer-readable carrier medium, e.g., a computer program product. The computer-readable carrier medium carries logic including a set of instructions that when executed on one or more processors cause the processor or processors to implement a method. Accordingly, the present invention may take the form of a method, an entirely hardware embodiment, an entirely software embodiment or an embodiment combining software and hardware. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, (i) in one set of embodiment, a tangible computer-readable medium, e.g., a solid-state memory, or a computer software product encoded in computer-readable optical or magnetic media; (ii) in a different set of embodiments, a medium bearing a propagated signal detectable by at least one processor of one or more processors and representing a set of instructions that when executed implement a method; (iii) in a different set of embodiments, a carrier wave bearing a propagated signal detectable by at least one processor of the one or more processors and representing the set of instructions a propagated signal and representing the set of instructions; (iv) in a different set of embodiments, a transmission medium in a network bearing a propagated signal detectable by at least one processor of the one or more processors and representing the set of instructions.

In the foregoing specification, specific embodiments of the present invention have been described. However, one of ordinary skill in the art appreciates that various modifications and changes can be made without departing from the scope of the present invention as set forth in the claims below. For example, the therapeutic light source and the massage component are not limited to the presently disclosed forms. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A system, comprising:
an user interface configured to enable an Internet user to input at least one query and receive at least one answer;
a crawler for collecting web contents from the Internet;
an indexer for receiving the query from said user interface and builds indexes of said web contents; and
a retriever for looking up said indexes and generating said least one answer to said at least one query.

2. The system as recited in claim 1, wherein said answers comprises paragraphs, bullets, tables and/or graphs that summarize and concisely represent web contents relevant to said queries.

3. The system as recited in claim 1, wherein said answers comprises text, images, video clips and/or sound tracks.

4. The system as recited in claim 1, wherein said indexer comprising a web content filter configured to receive said web contents from said crawler and extract valid web contents from said web contents;

5. The system as recited in claim 1, wherein said indexer comprising a syntactic and semantic annotator configured to receive said valid web contents from said web content filter and product syntactic and semantic annotations of said valid web contents.

6. The system as recited in claim 1, wherein said retriever is further configured to receive indexes of web contents relevant to said at least one query, and generate and return answers of said at least one query to said user interface.

7. The system as recited in claim 1 is configured to provide answers to domain-independent queries, or to queries on different platforms or in specific knowledge domains.

8. The system as recited in claim 1 is configured to provide paid service to enterprises, or free service to the Internet users.

9. The system as recited in claim 1 is configured to provide summary-style search results to hand-held devices.

10. The system as recited in claim 1 comprising a method comprising the steps of:
receiving queries from Internet users;
collecting web contents from the Internet;
extracting said valid web contents from said web contents;
building said indexes of said valid web contents;
generating said at least one answer to said at least one query; and
providing said at least one answer to said Internet users.

11. The system as recited in claim 10, wherein multimedia information, including text, images, video clips, sound tracks, is extracted from said web pages.

12. The system as recited in claim 10, wherein sentences are extracted from text.

13. The system as recited in claim 10, wherein invalid sentences are removed from said sentences.

14. The system as recited in claim 10, wherein phrases and semantic roles are identified from said sentences.

15. The method as recited in claim 10, wherein said sentences, images, video clips and sound tracks are indexed.

16. The method as recited in claim 10, wherein said retriever receives contents, including sentences, images, video clips and sound tracks, all of which being relevant to said at least one query from said indexer, and generates at least one answer to said query.
